(19) United States
(12) Patent Application Publication
(10) Pub. No.: US 2002/0145775 A1
(43) Pub. Date: Oct. 10, 2002

(54) TDM/WDMA passive optical network

(75) Inventors: Frank J. Effenberger, Freehold, NJ (US); S. Martin Mastenbrook, Concord, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Quantum Bridge Communications, Inc., Andover, MA (US)

(21) Appl. No.: 09/827,807

(22) Filed: Apr. 6, 2001

(51) Int. Cl. H04J 4/00; H04J 14/00; H04J 14/02

(52) U.S. Cl. 359/123; 359/124

(57) ABSTRACT

A communications network includes a passive optical network (PON), plural user terminals and a central terminal coupled to the PON. Each user terminal includes an optical transmitter for transmitting an upstream signal in an optical channel dedicated to the user terminal and an optical receiver for receiving a shared downstream signal in a shared optical channel. The central terminal includes an optical transmitter for transmitting the shared downstream signal and plural optical receivers each receiving one of the dedicated upstream signals. The central terminal optical transmitter transmits the shared downstream signal in a shared optical channel at wavelength λ₀ and the user terminal optical transmitters transmit the upstream signals in dedicated optical channels at dedicated wavelengths λ₁ to λ_{N}, respectively.

### BACKGROUND

A well-known optical fiber communications network includes a central terminal or optical line terminal (OLT), several user terminals or optical network terminals (ONTs) or optical network units (ONUs) and one or more optical distribution networks also referred to as passive optical networks (PONs). Such networks typically use time division multiplexing of time slots from the OLT downstream to the ONTs and time division multiple access of time slots from the ONTs upstream to the OLT over the PON. ITU Recommendation G.983.1 “Broadband Optical Access Systems Based on Passive Optical Networks” (October 1998) describes a generic architecture for passive optical networks.

Passive optical networks have several distinct advantages over other access networks. First, because the topology is a tree, a single central terminal on the network side communicates over a single fiber to a plurality of user terminals at the user end of the network. This distributes the cost of the network over more customers, making the network more efficient. Second, each user can access the full bandwidth of the network that all the users share. This allows for better service quality given a fixed amount of resources.

Despite these advantages, time division multiple access (TDMA) PONs do present several challenges, mostly at the physical layer of the network. Because the network uses passive multiplexing, the user terminals must be synchronized to high precision, e.g., one bit period, so that their transmissions will interleave correctly in the network. Also, because signals from multiple terminals are received in close succession, the receiver at the central terminal must have a very large and fast dynamic range. These challenges make it difficult to build a TDMA PON that runs at 622 Mb/s, and nearly impossible at higher speeds.

Use of wavelength division multiplexing (WDM) over PONs in both the upstream and downstream directions is known. In one system, every user terminal is allocated a fixed wavelength for transmission and for reception. Hence, every user enjoys a logical point-to-point connection, even though they share a common fiber. However, using WDM in PONs in both directions presents economic challenges. The sources and wavelength filters are expensive and must be tuned precisely to match each other across the system. There are generally a limited number of WDM channels available because 1) channel spacing must be large to increase tolerances, and 2) smaller channel count eases isolation requirements. Given the limited channel count, using WDM in both directions limits the total number of users that can share the same PON.

### SUMMARY

In most access networking applications, traffic concentration is a major fact of life. In the upstream direction, this means that the user needs a large dedicated bandwidth link so that bursts of data can be transmitted quickly into the network. The network then shapes and arbitrates such bursts with the bursts of other users, so that the resulting multiplexed flow utilizes the core network more efficiently. By contrast, downstream data has already passed through the network, and has been shaped and arbitrated such that it can pass through a shared link. Hence, a shared downlink is not considered a bottleneck.

The difficulties noted with TDMA PONs are in the upstream side of the PON. By using WDM to provide individual upstream channels to each user terminal the difficulties of TDMA are eliminated. At the same time, the downstream channel can be shared so as to avoid the expense and complexity of multiple transmitters at the network side terminal.

Accordingly, a communications network comprises a PON, plural user terminals and a central terminal coupled to the PON. Each user terminal includes an optical transmitter for transmitting an upstream signal in an optical channel dedicated to the user terminal and an optical receiver for receiving a shared downstream signal in a shared optical channel. The central terminal includes an optical transmitter for transmitting the shared downstream signal and plural optical receivers each receiving one of the dedicated upstream signals.

In an embodiment where there are N user terminals (N>1), the central terminal optical transmitter transmits the shared downstream signal in a shared optical channel at wavelength λ₀ and the user terminal optical transmitters transmit the upstream signals in dedicated optical channels at dedicated wavelengths λ₁ to λ_{N}, respectively. In one embodiment, wavelength λ₀ is at the 1310 nm band and the wavelengths λ₁ to λ_{N} are between 1500 and 1600 nm. In another embodiment, wavelength λ₀ and the wavelengths λ₁ to λ_{N} are between 1500 and 1600 nm.

According to an aspect of the network, the user terminals include a first group each having an optical transmitter that includes a coarse WDM laser and a second group each having an optical transmitter that includes a dense WDM laser. The first group includes user terminals having coarse WDM lasers that operate at first dedicated wavelengths. The second group includes user terminals having dense WDM lasers that operate at second dedicated wavelengths.

The central terminal includes a WDM filter array such as a thin-film filter device for separating the dedicated upstream channels for reception at the plural central terminal optical receivers. The user terminals each include a WDM filter for isolating the shared downstream channel for reception at the user terminal optical receiver.

In different embodiments, the shared downstream signal is either a static time division multiplex signal, a dynamic ATM time division multiplex signal or an Ethernet time division multiplex signal.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram illustrating the principles of the present system.

FIG. 2 is a block diagram of a first embodiment of the present system.

FIG. 3 illustrates a frequency spectrum allocation for the system of FIG. 2.

FIG. 4 is a block diagram of a second embodiment of the present system.

FIG. 5 illustrates a frequency spectrum allocation for the system of FIG. 4.

FIG. 6 is a block diagram illustrating static TDM multiplexing in the system of FIG. 1.

FIG. 7 is a block diagram illustrating dynamic ATM multiplexing in the system of FIG. 1.

FIG. 8 is a block diagram illustrating dynamic frame multiplexing in the system of FIG. 1.

### DETAILED DESCRIPTION OF THE INVENTION

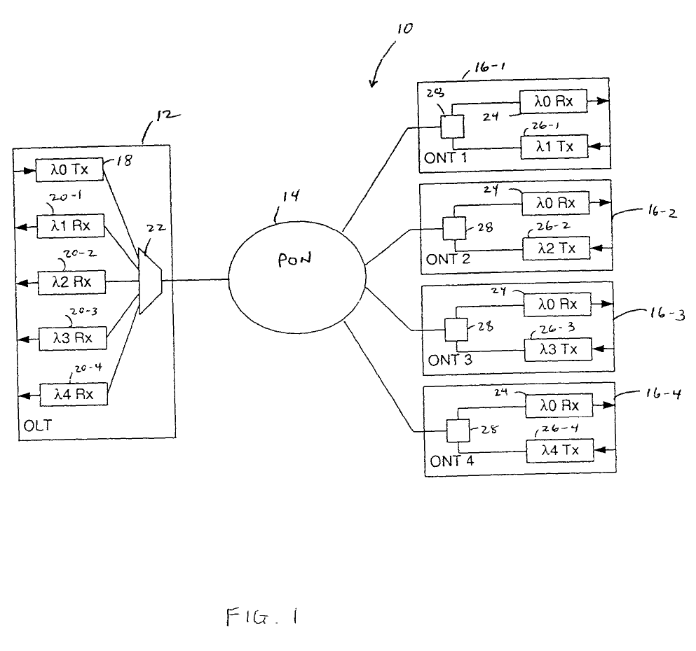

A passive optical network comprising a shared TDM downstream link and a set of dedicated WDM upstream links provides a very efficient high bandwidth capacity access network. A basic network configuration 10 is shown in FIG. 1 and includes a central terminal 12, a PON 14 and a plurality of user terminals 16-1, . . . , 16-N. For simplicity of description in this configuration, N=4.

In the embodiment of FIG. 1, the PON is a single fiber simple splitting type, with both upstream and downstream wavelengths on the same fiber, and no wavelength selective components in the PON. However, it should be understood that the principles of the present approach can be applied to embodiments in which the PON includes multiple fibers and wavelength selective components.

Note that the terms downstream and upstream are used herein to refer to the direction of transmission signal flow. The downstream direction refers to signals from the central terminal toward the user terminals. The upstream direction refers to signals from the user terminals toward the central terminal.

The central terminal 12, also referred to herein as an optical line terminal (OLT), includes an optical transmitter 18, plural optical receivers 20-1, . . . , 20-4, and a WDM filter array 22. The optical transmitter 18 includes a laser that transmits a shared downstream signal using wavelength λ₀. Each optical receiver 20-1, . . . , 20-4 includes a wavelength insensitive detector that receives an upstream signal at a particular dedicated wavelength λ₁, . . . , λ₄.

Each user terminal 16-1, . . . , 16-4, also referred to herein as an optical network terminal (ONT), includes an optical transmitter 26-1, . . . , 26-4, an optical receiver 24 and a WDM filter 28. The optical transmitters 26-1, . . . , 26-4 each include a laser that transmits an upstream signal at a particular dedicated wavelength λ₁, . . . , λ₄. The optical reciever 24 includes a detector that receives the shared downstream signal at wavelength λ₀ from the central terminal 12.

The network configuration 10 is an economical approach that is in marked contrast with a full WDM approach that requires N lasers, N detectors, and 2N filters at a central terminal and a laser, detector and filter at each of N user terminals.

Given the general arrangement of FIG. 1, several embodiments that take advantage of certain economies of optical components, or conform to other networking standards, are now described.

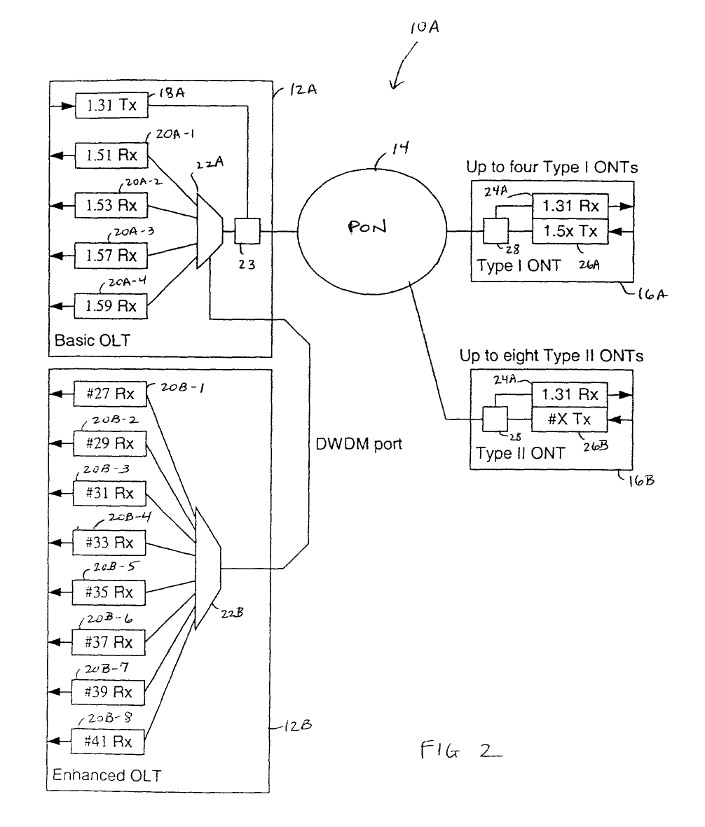

FIG. 2 shows a network configuration 10A which uses a TDM/WDM approach that minimizes costs. The network configuration includes a central terminal 12, a PON 14 and two types of user terminals referred to herein as type I ONTs 16A and type II ONTs 16B.

The central terminal includes a basic section 12A and an enhanced section 12B. The basic section 12A includes an optical transmitter 18A and plural optical receivers 20A-1, . . . , 20A-4, a WDM filter array 22A and a fused fiber filter 23. The downstream transmitter 18A includes a 1310 nm laser for transmitting a shared downstream signal. The optical receivers 20A-1, . . . , 20A-4 each include a detector that receives an upstream signal at a particular dedicated wavelength at 15xx nm, e.g., λ₁=1511 nm, λ₂=1531 nm, λ₃=1571 nm, λ₄=1591 nm. The enhanced section 12B includes WDM filter array 22B and plural optical receivers 20B-1, . . . , 20B-8. The optical receivers 20B-1, . . . , 20B-8 each include a detector that receives an upstream signal at wavelengths specified at ITU channels #27, 29, 31, 33, 35, 37, 39 and 41, respectively. Note that the ITU channels are specified at an interchannel spacing of 200 GHz.

The type I user terminals 16A each include an optical transmitter 26A at a dedicated wavelength λ₁=1511 nm, λ₂=1531 nm, λ₃=1571 nm, λ₄=1591 nm, respectively, an optical receiver 24A that includes a detector which receives the shared downstream signal at 1310 nm from the central terminal 12 and a WDM filter 28. The type II user terminals 16B each include an optical transmitter 26B at a dedicated wavelength specified at ITU channels #27, 29, 31, 33, 35, 37, 39 and 41, respectively. The type II user terminals also include optical receiver 24A for receiving the shared downstream signal at 1310 nm from the central terminal 12 and a WDM filter 28.

The type I user terminals 16A include coarse WDM lasers having respective wavelengths of 1511, 1531, 1571, and 1591 nm for the upstream optical channels. These lasers are inexpensive because of their large tolerances, and because they do not need cooling. The type II user terminals 16B include dense WDM lasers having ITU channel wavelengths #27, 29, 31, 33, 35, 37, 39 and 41, respectively. These dense WDM lasers are more expensive. In one possible application, the type I user terminals are first deployed, with the type II user terminals used in capacity relief deployments at a later time.

The WDM filter arrays 22A, 22B are thin-film filter type devices that separate the dedicated upstream channels for reception at the dedicated detectors. The fused fiber filter 23 is an inexpensive device used to add the downstream signal at the central terminal. At the user terminals 16A, 16B, the WDM filter 28 is also an inexpensive fused fiber filter that can be used to isolate the single downstream channel, and this filter also provides the point for launching the 15xx nm upstream signal. Hence, the user terminal is greatly cost reduced in this approach.

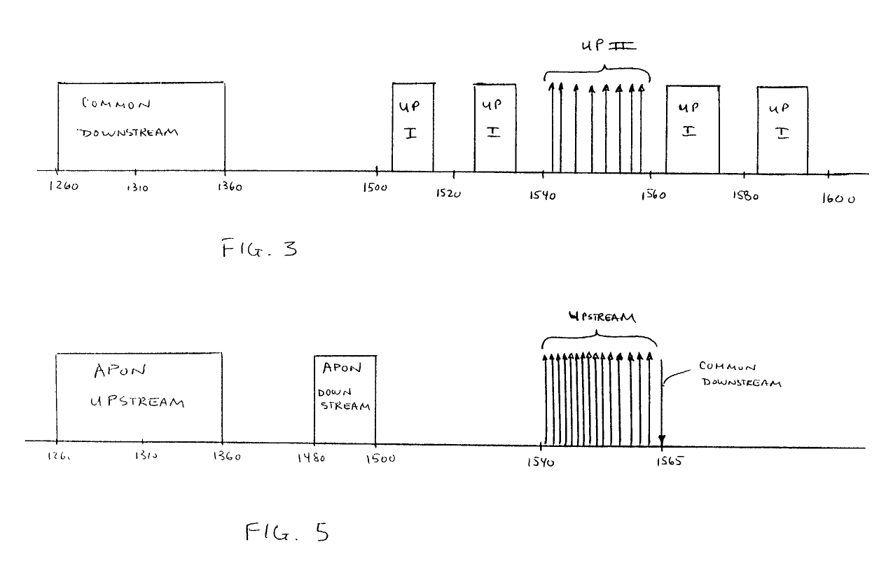

In the embodiment shown in FIG. 2 there are up to four type I user terminals and up to eight type II terminals. A frequency spectrum chart in FIG. 3 for this configuration illustrates allocation of the common downstream channel centered at the 1310 nm band, the upstream channels associated with the type I user terminals at 1511, 1531, 1551 and 1571 nm bands, respectively (indicated as UP I), and the upstream channels associated with the type II user terminals at ITU channels #27, 29, 31, 33, 35, 37, 39 and 41, respectively (indicated as UP II). However, it should be understood that with more dense channel spacings, additional channels and user terminals of either or both types I and II can be accommodated with the approach described.

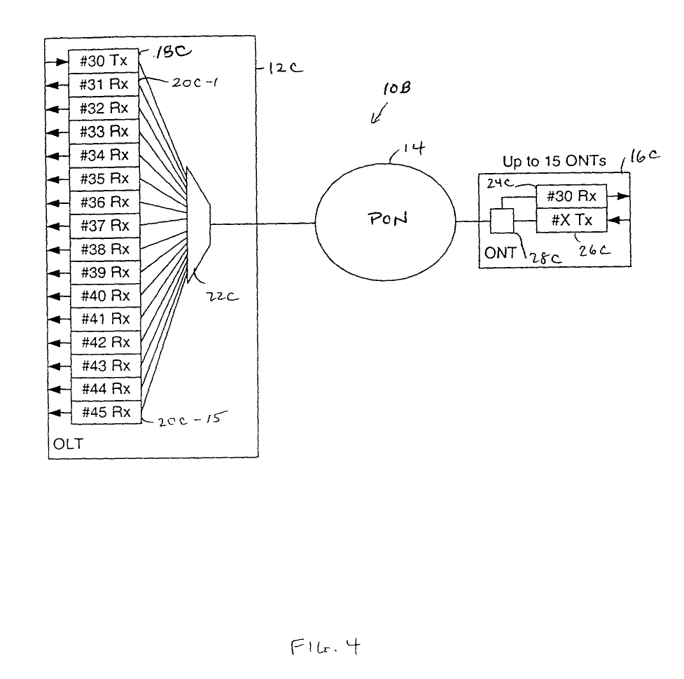

FIG. 4 shows a network configuration 10B which uses a TDM/WDM approach that is compatible with frequency spectrum allocations being specified in draft ITU Recommendation G.983.3. The G.983.3 draft recommendation specifies that the user side devices (ONTs) use the 1310 nm band to transmit upstream, and that the network side device (OLT) uses a laser in the 1480-1500 nm band for downstream (referred to as asymmetric PON or APON). Hence, both of these standard APON bands are occupied and unusable for WDM channels. The G.983.3 draft specifies an expansion band that is allocated from 1540 to 1565 nm for future services. However, such future services are not specified. This band is large enough to accommodate approximately 16 ITU channels, from #30 to #45.

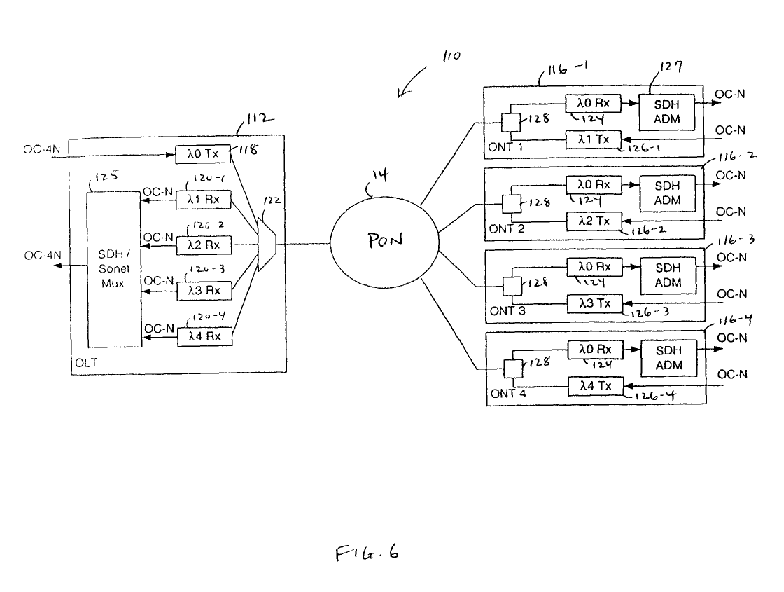

The TDM/WDM system shown in FIG. 3 uses channel #30 for the common downstream channel and the remaining 15 channels for individual upstream channels. The spectrum allocation for ITU channels #30 to #45 is shown in FIG. 5. Also shown are the standard APON upstream and downstream channels.

Referring again to FIG. 4, the network configuration 10B includes central terminal 12C, PON 14 and user terminals ONTs 16C.

The central terminal includes an optical transmitter 18C and plural optical receivers 20C-1, . . . , 20A-15 and a WDM filter array 22C. The downstream transmitter 18A includes a laser at ITU channel #30 for transmitting a shared downstream signal. The optical receivers 20C-1, . . . , 20C-15 each include a detector that receives an upstream signal at a particular dedicated wavelength at ITU channels #31 to #45, respectively. Note that the ITU channels are specified at an interchannel spacing of 100 GHz.

The user terminals 16C each include an optical transmitter 26C at a dedicated wavelength at ITU channels #31 to #45, respectively, an optical receiver 24C that includes a detector which receives the shared downstream signal at ITU channel #30 from the central terminal 12C and a WDM filter 28C. The user terminals 16C include dense WDM lasers at the specified ITU channel wavelengths.

The WDM filter array 22C at the central terminal and the WDM filter 28C at the user terminal are thin-film filters. However, the number of user terminals possible with this second embodiment (15) is nearly double the number possible with the first embodiment (8), given the ITU channel spacings described.

For any embodiment of the optical channel that uses shared TDM downstream, and dedicated WDM upstream, there are several approaches for the method of multiplexing the downstream. The simplest approach uses a standard synchronous digital hierarchy (SDH) time-slotted TDM link layer. In this approach, each user terminal is allocated some portion of the downstream bandwidth. Because this allocation is static, the data rate of the downstream must be greater than that of the upstream in most applications.

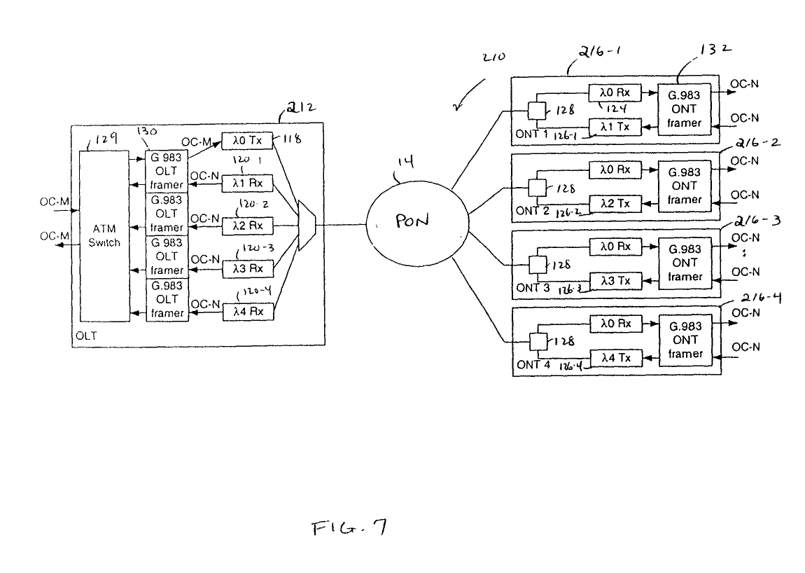

An SDH TDM approach is illustrated in the network configuration 110 shown in FIG. 6 that includes central terminal 112, PON 14 and user terminals 116-1, . . . , 116-4. The central terminal 112 includes optical transmitter 118, optical receivers 120-1, . . . , 120-4 and WDM filter array 122. The user terminals 116-1, . . . , 116-4 each include optical receiver 124, WDM filter 128 and optical transmitter 126-1, . . . , 126-4, respectively.

The central terminal further includes a standard SDH/SONET multiplexer 125 to combine the upstream traffic streams received from the user terminals 116-1, . . . , 116-4. The user terminals each include a SDH/SONET add-drop multiplexer 127 to extract the correct portion of the downstream signal.

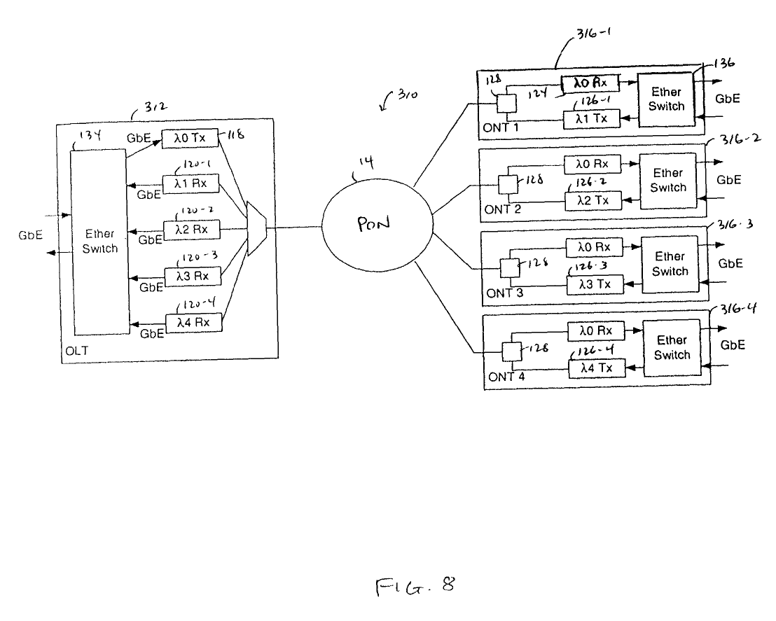

A more efficient alternative to static TDM multiplexing uses dynamic asynchronous transfer mode (ATM)-based TDM, as is found in the G.983.1 standard. An ATM configuration 210 is shown in FIG. 7. A central terminal 212 includes an ATM switch 129 and G.983 framers 130. User terminals 216-1, . . . , 216-4 each include a G.983 framer 132.

The central terminal 212 transmits the cells destined for all the users on the PON as they arrive at the network, and not in a pre-arranged order. This allows for the bandwidth of each user to dynamically change as needed. Each user terminal filters out only those cells that belong to it by looking at the ATM header. The operation of the downstream system is identical to a G.983.1 system, except that each user terminal is made to operate as if it has the entire upstream bandwidth to itself. Because of this similarity, standard G.983 chipsets can be used which makes implementation easier.

Another TDM approach uses an Ethernet link layer and is shown in FIG. 8. A central terminal 312 includes an Ethernet switch 134. User terminals 316-1, . . . , 316-4 each include an Ethernet switch 136.

In network configuration 310, Ethernet frames for all users are transmitted downstream on the PON, and user terminals filter traffic based on the Ethernet MAC address. All of these functions can be accomplished by commonplace Ethernet switching chip sets, making this embodiment very economical, as well as efficient for packet-only data flows.

While this invention has been particularly shown and described with references to preferred embodiments thereof, it will be understood by those skilled in the art that various changes in form and details may be made therein without departing from the scope of the invention encompassed by the appended claims.

What is claimed is:

1. A communications network comprising:
a passive optical network (PON);
plural user terminals coupled to the PON, each user terminal having an optical transmitter for transmitting an upstream signal in an optical channel dedicated to the user terminal and an optical receiver for receiving a shared downstream signal in a shared optical channel;
a central terminal coupled to the PON and having an optical transmitter for transmitting the shared downstream signal and plural optical receivers each receiving one of the dedicated upstream signals.

2. The communications network of claim 1 wherein the central terminal includes a WDM filter array for separating the dedicated upstream channels for reception at the plural central terminal optical receivers.

3. The communications network of claim 1 wherein the WDM filter array comprises a thin-film filter device.

4. The communications network of claim 1 wherein the user terminals each include a WDM filter for isolating the shared downstream channel for reception at the user terminal optical receiver.

5. The communications network of claim 1 wherein there are N user terminals (N>1) and wherein the central terminal optical transmitter transmits the shared downstream signal in a shared optical channel at wavelength λ₀ and the user terminal optical transmitters transmit the upstream signals in dedicated optical channels at dedicated wavelengths λ₁ to λ_{N}, respectively.

6. The communications network of claim 5 wherein wavelength λ₀ is at the 1310 nm band and the wavelengths λ₁ to λ_{N} are between 1500 and 1600 nm.

7. The communications network of claim 1 wherein the central terminal optical transmitter transmits the shared downstream signal in a shared optical channel at wavelength λ₀ and wherein the plural user terminals include a first group of user terminals each having an optical transmitter that includes a coarse WDM laser and a second group of user terminals each having an optical transmitter that includes a dense WDM laser.

8. The communications network of claim 7 wherein the first group comprises up to four user terminals having coarse WDM lasers that operate respectively at dedicated wavelengths of 1511, 1531, 1571 and 1591 nm.

9. The communications network of claim 7 wherein the second group comprises up to eight user terminals having dense WDM lasers that operate at dedicated ITU channels.

10. The communications network of claim 9 wherein the ITU channels include ITU channels #27, #29, #31, #33, #35, #37, #39 and #41.

11. The communications network of claim 7 wherein wavelength λ₀ is at the 1310 nm band.

12. The communications network of claim 5 wherein wavelength λ₀ and the wavelengths λ₁ to λ_{N} are selected from channels between 1500 and 1600 nm.

13. The communications network of claim 12 wherein wavelength λ₀ and the wavelengths λ₁ to λ_{N} are selected from channels in the 1540 to 1565 nm band.

14. The communications network of claim 13 wherein wavelength λ₀ is at ITU channel #30 and for N less than 16, the wavelengths λ₁ to λ_{N} are selected from ITU channels #31 to #44, respectively.

15. The communications network of claim 1 wherein the central terminal includes an SDH/SONET multiplexer, the user terminals each include an SDH/SONET add-drop multiplexer and the shared downstream signal is a static time division multiplex signal.

16. The communications network of claim 1 wherein the central terminal includes an ATM switch and framer, the user terminals each include an ATM framer and the shared downstream signal is a dynamic ATM time division multiplex signal.

17. The communications network of claim 1 wherein the central terminal and the user terminals each include an Ethernet switch and the shared downstream signal is an Ethernet time division multiplex signal.

18. In a communications network, a method of communications comprising:
coupling plural user terminals and a central terminal to a passive optical network (PON);
at each user terminal, transmitting an upstream signal in an optical channel dedicated to the user terminal and receiving a shared downstream signal in a shared optical channel;
at the central terminal, transmitting the shared downstream signal and receiving one of the dedicated upstream signals at a plurality of optical receivers.

19. The method of claim 18 wherein there are N user terminals (N>1) and wherein the central terminal transmits the shared downstream signal in a shared optical channel at wavelength λ₀ and the user terminals transmit the upstream signals in dedicated optical channels at dedicated wavelengths λ₁ to λ_{N}, respectively.

20. The method of claim 19 wherein wavelength λ₀ is at the 1310 nm band and the wavelengths λ₁ to λ_{N} are between 1500 and 1600 nm.

21. The method of claim 19 wherein wavelength λ₀ and the wavelengths λ₁ to λ_{N} are between 1500 and 1600 nm.
